(19) United States
(12) Patent Application Publication
(10) Pub. No.: US 2010/0174568 A1
(43) Pub. Date: Jul. 8, 2010

(54) METHOD AND SYSTEM FOR VALIDATING OPEN BASIS RESRVATION AT LODGING

(76) Inventor: John Thomas Burke, JR., Charleston, SC (US)

Correspondence Address: MOORE & VAN ALLEN PLLC, P.O. BOX 13706, Research Triangle Park, NC, 27709, US

(21) Appl. No.: 12/725,160

(22) Filed: Mar. 16, 2010

Related U.S. Application Data
(63) Continuation of application No. 11/767,017, filed on Jun. 22, 2007, now abandoned.

(51) Int. Cl. G06Q 50/00; G06Q 10/00; G06Q 20/00

(52) U.S. Cl. 705/5

(57) ABSTRACT

A method of doing business, and related system, for a pre-reservation on an open basis, namely for a guaranteed room on a future unspecified date or future unspecified dates at lodging, which belongs to a group of pre-selected lodgings in a designated geographic area, where the open basis reservation can be converted to a guaranteed room on a specified date or dates. The method and system are useful in one or both of a disaster/emergency or absence of a disaster/emergency.

### BACKGROUND OF INVENTION

The present invention is directed to a method and system of doing business for a reservation on an open basis (also referred to as a booking on an open basis), in order to be guaranteed a room on a future unspecified date at lodging (i.e., a hotel, a motel, an inn, a bed & breakfast, et cetera) belonging to a pre-selected group of lodgings in a specified relevant geographic area. More particularly in one embodiment, the method and system relate to an individual paying a recurring fee on a periodic basis, i.e., a recurring selected time basis such as paying a fee once per year, and then, in an emergency requiring evacuation, for instance an event like an approaching hurricane, the individual who has subscribed by paying the yearly fee is guaranteed a room at one of the lodgings in the group by the individual accessing that reservation and converting it to a guaranteed room for specified day(s). For instance, when the individual initially subscribes, the individual may be given or may designate a code that relates to the individual's identification information so that the individual can email or telephone his/her code or enter his/her code on a web site for the pre-selected group, thereby converting his/her reservation to a guaranteed room at lodging in the pre-selected group for specified day(s).

The following abbreviations are employed here.

ABBREVIATIONS

| | |
|---|---|
| B&B | bed and breakfast |
| CPU | central processing unit |
| CRS | computerized reservation system |
| GRR | guaranteed room reservation |
| III | identification information on the individual |
| OBR | open basis reservation |
| RFID | radio frequency identification |
| RAM | random access memory |
| ROM | read only memory |

Of background interest is, for instance, U.S. Pat. No. 4,072,825, issued Feb. 7, 1978 to McLay, et al., assignors to Mi-Tronics, Inc. This patent depicts a microprocessor control system for monitoring and controlling a plurality of different parameters or features of a large number of like-kind entities.

Also of background interest is U.S. Pat. No. 6,094,640, issued Jul. 25, 2000 to Goheen, assignor to The Pugliese Company. This patent depicts a method and system of issuing an electronic authorization and validation for pre-scheduled activities, such as airline reservations, to eliminate paper tickets.

Additionally of background interest is U.S. Pat. No. 6,738,750, issued May 18, 2004 to Stone, et al. This patent depicts a method and apparatus that allows for the verification and substantiation of the purchase of access or admission to facilities, sites, businesses, venues, sporting events, or reserved services that traditionally have controlled access by means of tickets, passes, admission documents, reservations, reservation confirmations, or other substantiation.

Furthermore, of background interest is U.S. Pat. No. 6,895,381, issued May 17, 2005 to Selby, assignor to International Business machines Corporation. This patent depicts a system and method for predicting the likelihood of materialization of pending wait-listed reservations for the purchase of perishable commodities.

Also of background interest is U.S. Pat. No. 6,993,503, issued Jan. 31, 2006 to Heissenbuttel, et al., assignors to Priceline.com Incorporated. This patent depicts a system and method of allocating a conditional purchase offer for a product or service to one of a plurality of entities in a buyer-driven system.

Additionally of background interest is U.S. Pat. No. 7,184,989, issued Feb. 27, 2007 to Hansen, et al., assignors to First Data Corporation. This patent depicts a system and method for accepting payments for goods and services provided by a merchant.

Furthermore, of background interest is Japanese Published Patent Application 2002/175457, published Jun. 21, 2002 to Masuno. This published patent application shows a hotel reservation system operable from a portable telephone, and having a position recognizing function and a counter for accepting a reservation and for recognizing position information transmitted from the portable telephone.

Also of background interest is Japanese Published Patent Application 2001/167162, published Jun. 22, 2001 to assignee Map Japan KK. This published patent application shows an internet stay reservation system with stay condition data including utilization fee, desired accommodation region, and desired stay time.

Furthermore, of background interest is Japanese Published Patent Application 2002/132972, published May 10, 2002 to assignee I Market. This published patent application shows an empty room information system for hotels, which system has an information center that receives information about empty rooms from an accommodation establishment and transmits the received information to each stay reservation site.

Additionally of background interest is Japanese Published Patent Application 2003/256703, published Sep. 12, 2003 to Iwasaki, assignor to Minamikyushu Rental & Leasing Co. Ltd. This published patent application shows a hotel accommodation reservation system for on-the-day hotel reservations, which system has a service provider-side terminal device, a user terminal device, and a reservation mediating device connected through a communication line.

Lastly, it is noted that of general background interest vis-á-vis business methods is NETFLIX, which is service with online access (e.g., the Internet) that allows the customer to pay a monthly service fee in order to be able to receive DVD movies by having them delivered through the regular mail and then returning them through the regular mail, for as often as the customer desires.

The disclosures of all patents and published patent applications, which are mentioned here, are incorporated by reference.

### SUMMARY OF INVENTION

The present invention provides a method for validating an open basis reservation for a room at a particular lodging, where the particular lodging belongs to a group of pre-selected lodgings in a designated geographic area, said method comprising the steps of: (a) making a reservation, on an open basis for an individual for a room in the group of pre-selected lodgings on a future unspecified day or days, by providing identification information on the individual and paying a fee for a term, (b) storing reservation data in a reservation data storage area of a central controller, where the data includes the identification information on the individual and includes the group of pre-selected lodgings for which the open basis reservation has been made by the individual, and (c) including ability to convert the open basis reservation to a guaranteed reservation for a room at the particular lodging belonging to the group of pre-selected lodgings for one or more specified days within the term, whereby access to the room can be effected by the individual for the one or more specified days, upon the central controller again obtaining the identification information on the individual when subsequently provided by the individual transmitting the identification information on the individual. Also, the method may further include the central controller again obtaining the identification information on the individual when subsequently provided by the individual transmitting the identification information on the individual whereby access to the room is effected by the individual for one or more specified days. In one embodiment, the method includes registering the open basis reservation and the identification information on the individual, on a government website for registration of evacuation plans.

Furthermore, the present invention provides a system for validating an open basis reservation for a room at a particular lodging, where the particular lodging belongs to a group of pre-selected lodgings in a designated geographic area, said system comprising: (i) an electronic reservation data storage device of a central controller, said reservation data storage device (a) being for storing open basis reservation data received from an individual making a reservation, on an open basis, for a room in the group of pre-selected lodgings on a future unspecified day or days by providing identification information on the individual and paying a fee for a term, and (b) being capable of fulfilling the open basis reservation, where the reservation data includes identification information on the individual and includes the group of pre-selected lodgings for which the open basis reservation has been made by the individual, and (ii) a central processing unit of a central controller, said central processing unit (a) being for processing the open basis reservation for a room in the group of pre-selected lodgings on a future unspecified day or days, and (b) being in communication with the reservation data storage device in order to identify appropriate lodgings in the group of pre-selected lodgings capable of fulfilling the open basis reservation, and (iii) wherein the central controller has the ability (a) to search a database stored in the electronic storage device and accept the open basis reservation, and (b) to convert the open basis reservation to a guaranteed reservation for a room at the particular lodging belonging to the group of pre-selected lodgings for one or more specified days within the term, whereby access to the room can be effected by the individual for the one or more specified days, upon the central controller again obtaining the identification information on the individual when subsequently provided by the individual transmitting the identification information on the individual. In one embodiment, the system includes an evacuation-plan government website for registering the open basis reservation and registering the identification information on the individual.

### BRIEF DESCRIPTION OF DRAWINGS

FIG. 1 is a block diagram showing the inventive OBR system;

FIG. 2 is a block diagram showing the architecture of an illustrative central controller; and

FIG. 3 is a block diagram showing a government website for individuals to register their evacuation plans.

### DESCRIPTION

As noted above, the present invention comprises a method of doing business for a reservation on an open basis at lodging in a pre-selected group of lodgings, namely for a guaranteed room on a future unspecified date or dates at lodging in the pre-selected group.

The term lodging, as used here, is meant to include, but not be limited to, a hotel, a motel, an inn, a B&B, et cetera, and is to include those lodgings that are independent, as well as those lodgings that belong to a chain.

The term open basis reservation, as used here in relation to a lodging room, means that a purchaser of such reservation is guaranteed a room on future unspecified day(s) at lodging in a pre-selected group in a designated geographic area, when the purchaser converts his/her reservation to a guaranteed room for specified day(s) at lodging in the pre-selected group. The term reservation is used here interchangeably with the term booking.

The term shelter or public shelter, as used here, is meant to include, but not be limited to, places designated by a government unit to be used as housing for persons who evacuate their own housing in a disaster/emergency situation, such as an approaching hurricane. Such places include, but are not limited to, schools, sports arenas, houses of worship, et cetera.

The term individual, as used here, is meant to include one person, as well as a group of persons, for instance a husband and wife and their children, or for instance two or more friends, who (i) make the open basis reservation for the room and/or (ii) have access to the room when the reservation is converted, thereby providing access to the room.

The term disaster/emergency, as used here, is meant to include, but not be limited to, situations such as a plant explosion and/or plant leak (i.e., from a nuclear power plant, from a hazardous waste storage plant, and the like), a terrorist threat, an approaching hurricane, a forest fire, et cetera.

The term blackout day, as used here as used here in relation to a lodging room, means the well known term as is employed in the travel industry and/or lodging industry for a day that is very popular and thus for which bookings are high and occur early, and thus, for which the travel industry and/or lodging industry blacks out from their point programs, namely the points that a customer collects for usage so that the customer can some time in the future have a free or reduced rate room, airplane ticket, et cetera. In other words, the customer cannot use collected points for a free or reduced rate room, airplane ticket, et cetera, on a blackout day.

More particularly, most every lodging chain has a computerized system to make reservations and to market rooms which are available on the current date and/or which are available on future specified dates. Typical vacancy rates are around 25% for any given date.

Nevertheless at present, to the best of the knowledge of the inventor, a method and system do not exist where individual lodgings and/or lodgings in a chain are able to market room reservations on an open date basis, although the desire for an OBR system appears to have arisen shortly after Hurricane Floyd came through Florida in 1999. Hurricane Floyd resulted in a situation with traffic gridlock and a volume of telephone calls to lodgings so huge that many of the persons calling were unable to have any telephone call go through to any lodgings. Then in 2005, Hurricane Katrina came through Louisiana. Although Hurricane Katrina resulted in a situation with traffic gridlock and a volume of telephone calls far more exacerbated than the 1999 situation from Hurricane Floyd, and also with tying up the internet (as internet technology for booking lodgings had greatly expanded in 2005 compared to 1999), still there was no OBR system.

The present invention involves a method and a system for marketing rooms on an open basis, which may be employed any time, even in the absence of a disaster/emergency. However, in one particular embodiment, such marketing is very useful when there is a disaster/emergency, for instance, a plant explosion and/or plant leak (i.e., from a nuclear power plant, from a hazardous waste storage plant, and the like), a terrorist threat, an approaching hurricane, a forest fire, et cetera.

In general, the OBR method and system involve that each lodging (independent lodgings and/or chain lodgings) joins a group, i.e., a consortium, in which an average of all available rooms is offered for reservations on future dates, and particularly, the OBR is available if a disaster/emergency were to occur such that evacuation should take place. The inventive system combines the rooms of the various lodgings in the group of pre-selected lodgings into one electronic site and/or toll free telephone number.

Individuals, who desire to be subscribing customers for a guaranteed room on a future unspecified date or dates during a term, pay in advance a certain amount of money for a reservation on an open basis. In other words, the customer pays a recurring fee on a recurring selected time basis. For instance, the individual pays a fee once per year, and of course, the individual could choose not to continue after the term expires. Desirably, the periodic fee would provide for a guaranteed room for at least one day, more desirably, at least three days during the term. Increasing fee schedules could be provided for whether an individual desires to be guaranteed 1 day, 2 days, 3 days, et cetera, during the term, and also optionally, increasing fee schedules could be provided for whether an individual desires to be guaranteed the day(s) on blackout days, such as annual events in the designated geographic area (i.e., the Spoleto Festival of Performing Arts that is held annually in Charleston, S.C.) or such as government designated official holidays (i.e., Christmas or Christmas Eve) during the term. For instance, an individual could pay the increased fee for a total of 6 days, including if any of these fall on a holiday, and then for instance, the individual could use 3 days when there is a hurricane in June and then use the remaining 3 days starting Christmas Eve for a vacation or for when there is an earthquake on Christmas Eve. An individual who subscribes by periodically paying the fee may be given a code or may select a code when the individual first subscribes, where the code relates to the individual's identification information. The code may be alphabetic, numeric, or alpha-numeric.

Then, the individual can access that reservation, such as by entering his/her code on a website for the pre-selected group or by emailing or telephoning his/her code, and thereby the individual can convert his/her open basis reservation to a guaranteed room at lodging in the pre-selected group for specified day(s). Also, it is contemplated that the individual can deal through a travel agent, if the individual so desires, instead of dealing directly by himself/herself.

When a disaster/emergency occurs, the individual can access his/her OBR, and can convert it to a guaranteed room at lodging in the pre-selected group for specified day(s). Furthermore in one embodiment, it is contemplated that in the event that a disaster/emergency does occur and the government issues an evacuation order, the individual forfeits his/her right to convert his/her OBR to a guaranteed room at lodging in the pre-selected group for specified day(s) during the instant disaster/emergency for which the government issued the evacuation order, unless the individual accesses his/her OBR and converts within a specified time, such as within 4 hours, after the government evacuation order has been issued. The lodging room will then be available to the general public during the instant disaster/emergency for which the government issued the evacuation order. Also, it is contemplated that if the individual does convert (whether for a disaster/emergency or for a non-disaster/non-emergency such as a vacation) and fails to show up, then, as is standard practice in the lodging industry, the individual will be charged for the first converted day, and his/her remaining converted days, if any, will be canceled.

As noted above, it is also contemplated that even if a disaster/emergency does not occur, the individual still has the option to access his/her OBR, and to convert it to a guaranteed room at lodging in the pre-selected group for specified day(s). This could provide an advantage to the lodging industry by the lodgings optionally providing a tie in with their customer loyalty programs so that that an individual who indeed converts his/her OBR to a guaranteed room, even in the absence of a disaster/emergency, is rewarded with a reduced room rate, a free room for one or more nights, et cetera, as a reward for doing a certain amount of business with the lodging. Also optionally, such customers could be provided special access to the selection of reservations, thus providing increased incentives at loyalty.

An advantage is that in general the fees generated by such open basis reservations would be pure profit to the lodgings since an open basis reservation by an individual typically would not result in the individual actually using the room. Also, although a particular lodging on any given date may not have a vacancy rate as high as 25%, by the particular lodging marketing its reservations through a consortium, overbooked rooms could be applied to other lodgings in the consortium that are in the same area. Hence, the system according to the present invention should help obviate overbooking and allow for optimal income for the lodgings in the consortium. Another benefit is that the present invention should help decrease the number of telephone calls and website hits that a particular lodging would receive via its current reservation system, when a disaster/emergency occurs.

Presently, the United States government goes to great expense to develop evacuation plans, find shelter space, et cetera, for its residents in the event of a disaster/emergency. However, the United States government emphasizes that it is the individuals' responsibility to make their own evacuation plans and to have enough supplies on hand to sustain themselves and their families for a minimum of 3 days. Accordingly, even though currently there is no system to facilitate such individual planning, the United States government's evacuation plans rely on individuals using designated public shelter as a place of last resort. History has shown not only that many individuals tend to use shelter as a place of last resort, but also that many individuals tend to wait until the last minute. More specifically, a large number of people take the attitude of “I will find a motel, a hotel, et cetera, at the approach of an emergency”, which results in people making plans at the last minute, and as noted above with respect to Hurricane Katrina in 2005, a situation with traffic gridlock and with the tying up of telephone lines and the internet. The result is a great hampering of the United States government's evacuation plans for how many shelter spaces, et cetera, are actually needed for its residents in the event of a disaster/emergency.

An OBR system should help obviate this problem. Hence, in another embodiment, it is also envisioned that the United States government would require people who live in areas that are designated by the United States government as being areas prone to disasters/emergencies (i.e., coastal residents in designated hurricane areas, residents in designated earthquake areas, residents in designated nuclear power plant areas, residents in designated hazardous waste storage plant areas, and the like) to register their individual information and their evacuation plans, including destination, on a government website. This website may be a state website or county website, but preferably, this website is one United States government website (or a website from a private company with which the United States government has contracted) so that there is coordination throughout all of the United States for all of the evacuation plans for each individual who registers. It is envisioned that the United States government, or other smaller government units, may promote civic organizations, sister city programs, et cetera, to assist in coordinating with designated places to be used as public shelters. Also, it is contemplated that other countries, besides the United States, may set up and operate such a government website for individuals respectively of those other countries to register their individual information and their evacuation plans, including destination, on the respective government websites.

The registration of evacuation plans on the government website will facilitate government officials planning how many spaces are needed in shelters versus how many people have paid for and thus are registered with the lodging system for open basis reservations. The website also will have a listing of United States government specified safe areas. In connection therewith, the fees for open basis reservations optionally would be higher for lodging rooms which are within government specified safe areas that are closer to the areas prone to disasters/emergencies, and the fees would decrease the farther that the distance is away from the government specified safe areas.

Thus, the registry would create an atmosphere which would encourage persons to purchase an OBR. Therefore, not only is the lodging industry benefited, but also the United States government is benefited by streamlining of evacuation during a disaster/emergency as the government would know from the registry that various lodgings are taken by persons purchasing OBRs. By individuals having the method of an OBR encouraging them to make their own plans, it is envisioned that in the event of a disaster/emergency, the United States government would be able to notify its citizens that all public shelter has become unavailable, sooner than the United States government is currently able to notify its citizens of unavailability of public shelter. Most desirably, a website registry would at some point in time reflect that a sufficient number of persons in some designated area had registered for public shelter in that area so that at that point in time, the public would be notified by the government that all public shelter in that area would be unavailable should a disaster/emergency occur, thus encouraging persons who had not registered on the website for public shelter instead to make plans with family or friends or to obtain an OBR.

Also, this registration of evacuation plans on a government website optionally would include the government issuing registration for vehicles with RFID technology, so that the addresses of the vehicle owners would be recorded so that vehicle owners who reside within a certain area could be assigned a certain window of time and a certain route for evacuation, with RFID readers set up on access points to the evacuation routes. Fines could be levied for those people not leaving in accordance with their assigned window of time and evacuation route.

Additionally, it is envisioned that the government may view use of the method and system during a disaster/emergency as akin to use of insurance, and thus, the government may regulate the lodging consortium with respect to having them obtain approval from the government to institute a rate increase for individuals who are subscribers to the method and system and who have used it during a disaster/emergency. In connection with a rate increase to subscribers, it is envisioned that the lodging consortium may have the option to tailor rates for an OBR according to type of usage. In other words, if a subscriber converts his/her OBR to a GRR for a vacation, then the lodging consortium would give the subscriber a rate increase when the subscription term is about to expire and the subscriber again subscribes for another term, whereas if a subscriber did not convert his/her OBR to a GRR or converted his/her OBR to a GRR for a disaster/emergency, then the lodging consortium would not give the subscriber a rate increase when the subscription term is about to expire and the subscriber again subscribes for another term.

Also, it is contemplated that other countries, besides the United States, may set up and operate such a government website for individuals respectively of those other countries to register their individual information and their evacuation plans, including destination, on the respective government websites.

The invention is now described in more detail below with reference to the Figures and Example, and is not to be limited thereby.

With reference now to the Figures, whenever possible, the same reference numerals and letters are used throughout to refer to the same or like parts.

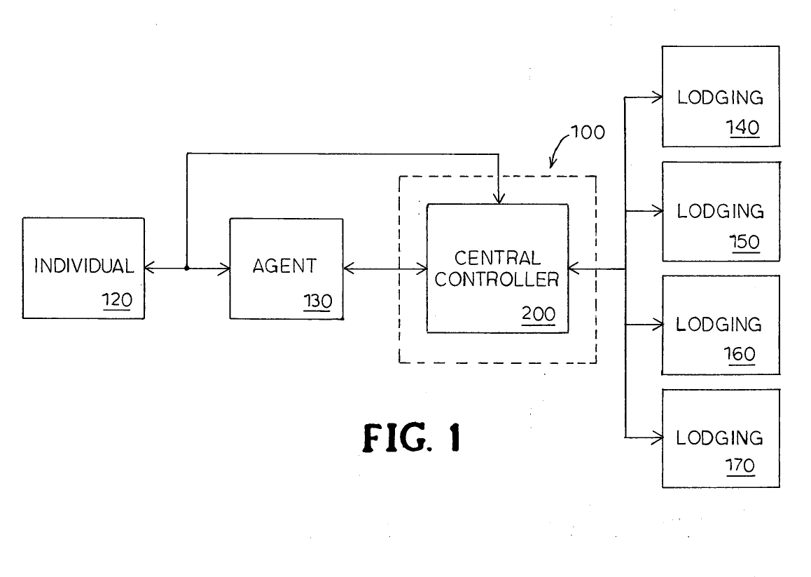

More specifically, shown in FIG. 1 is inventive OBR system 100, which preferably includes central controller 200. Individual 120 who desires to be a purchaser of an OBR contacts system 100, for example, by means of online access (e.g., the Internet), electronic mail (email), telephone, facsimile, or in-person contact, or optionally through agent 130, and provides system 100 with the individual's identification information III, and pays a subscribing fee for a term. Preferably, individual 120 is given or designates a code when he/she first subscribes and pays the fee.

System 100 may provide a given OBR to selected lodgings 140, 150, 160, 170 based on pre-defined criteria, such as lodgings 140, 150, 160, 170 belong to a group or consortium, so that lodgings 140, 150, 160, 170 obtain only OBRs for which lodgings 140, 150, 160, 170 have the potential to fulfill when individual 120 converts his/her OBR to a guaranteed room for specified day(s). Desirably, the fee would provide for a guaranteed room for at least 1 night, more desirably, at least 2 nights, even more desirably, at least 3 nights, with increasing fee schedules related to how many nights an individual desires to have guaranteed. It is contemplated that the inventive OBR method and system may be employed any time for conversion to a GRR, even in the absence of a disaster/emergency, but particularly the invention is useful when there is a disaster/emergency, for instance, a plant explosion and/or plant leak (i.e., from a nuclear power plant, from a hazardous waste storage plant, and the like), a terrorist threat, an approaching hurricane, a forest fire, et cetera. Optionally, in the event that a disaster/emergency does occur and the government issues an evacuation order, but the individual fails to access his/her OBR and to convert it to GRR at lodging in the pre-selected group for specified day(s) within a specified time, such as within 4 hours, after the government evacuation order has been issued, then the lodgings 140, 150, 160, 170 may make the lodging room available to the general public during the instant disaster/emergency for which the government issued the evacuation order, and make the individual forfeit his/her right to convert his/her OBR to a guaranteed room at lodging in the pre-selected group for specified day(s) during the instant disaster/emergency for which the government issued the evacuation order.

It is noted that each individual 120 and the various lodgings 140, 150, 160, 170 may employ a general-purpose computer (not illustrated) for communicating with system 100, such general-purpose computer typically comprising a processing unit, a communication device (e.g., a modem), memory means and any software required to communicate with system 100.

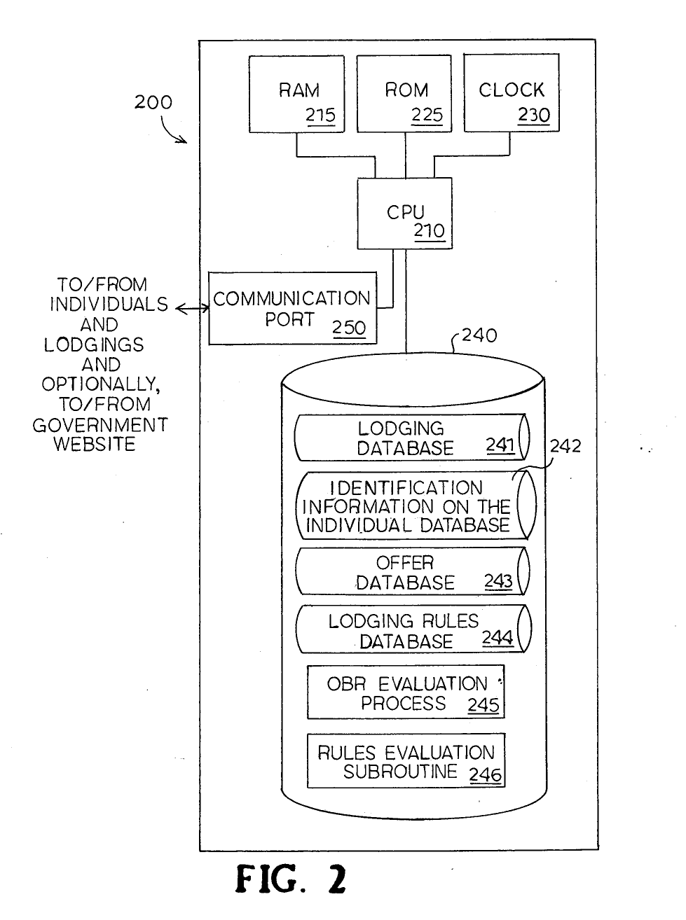

FIG. 2 is a block diagram illustrating an exemplary central controller 200, which preferably includes certain standard components, such as CPU 210, RAM 215, ROM 225, clock 230, data storage device 240, and communication port 250. Preferably, CPU 210 is linked to each of the other recited elements by means of a shared data bus or dedicated connections, as is illustrated in FIG. 2. Communication port 250 connects central controller 200 to individual 120 and to lodgings 140, 150, 160, 170, and suitably has multiple communication channels for simultaneously establishing a plurality of connections.

Central controller 200 may, in one embodiment, operate as a web server and provide a web page that is accessible on the World Wide Web, for both receiving and transmitting OBRs generated by individual 120. Individual 120 and lodgings 140, 150, 160, 170 may employ conventional communications software, as is known in the art, in order to communicate with central controller 200 of management system 100.

CPU 210 is operable to retrieve, interpret and execute one or more instructions, which ROM 225 and/or data storage device or area 240 are operable to store. For instance, ROM 225 and/or data storage device 240 may suitably store processes in order to accomplish transfer of required payments, charges and debits between individual 120 and lodgings 140, 150, 160, 170. Individual 120 may be given a code or designate a code when individual 120 first subscribes and pays the fee, where the code relates to the III. The processing of such accounting transactions may be secured with cryptographic techniques in a conventional manner, as is known in the art.

Data storage device 240 preferably includes lodging database 241, database 242 for identification information for the individual, offer database 243, and lodging rules database 244, and more preferably, also includes OBR evaluation process 245 and rules evaluation subroutine 246.

Lodging database 241 stores information on each lodging 140, 150, 160, 170 that is in the group or consortium and that is thus registered with system 100 to sell OBRs to individuals 120, and also lodging database 241 includes contact information on each lodging 140, 150, 160, 170.

III database 242 suitably stores identification information on each individual 120, including billing information, such as a credit card number, so that individual 120 may pay the fee for the OBR for a certain term, such as for 1 year. Optionally, database 242 may generate on a periodic basis, a reminder, such as an email notice or a regular mail notice, to individual 120, when the term or period of the paid subscribing fee is about to expire, so that individual 120 can periodically pay the fee again for renewing the term. Also optionally, this may include that when individual 120 makes the first payment, individual 120 may elect the automatic periodic payment for renewing the term, until individual 120 gives notice to stop the automatic periodic payment.

Offer database 243 suitably contains a record of each OBR being processed by system 100, including the conditions associated with the OBR and the associated status of the OBR.

Lodging rules database 244 suitably maintains the OBR rules for one or more agents 130 through which lodgings 140, 150, 160, 170 may sell OBRs to individuals 120, so that individual 120 can deal through a travel agent 130 instead of directly by himself/herself, if he/she so desires.

OBR evaluation process 245 receives each OBR request from each individual 120, and provides each OBR to the appropriate lodgings 140, 150, 160, 170. Also, OBR evaluation process 245 evaluates each OBR against the appropriate rules in lodging rules database 244 and determines acceptance of the OBR by lodgings 140, 150, 160, 170. Rules evaluation subroutine 246 is executed by OBR evaluation process 245, which receives an OBR and compares the OBR against the rules in lodging rules database 244 in order to generate a response on behalf of lodgings 140, 150, 160, 170 to the particular OBR. Optionally, one or more of lodgings 140, 150, 160, 170 may employ a CRS (not shown), such as a reservation system that is centralized, for instance, Pegasus, Marsha, Wizcom, Apollo, or such as a global distribution system, that contains information about lodging room prices, such CRSs being well known in the art, as discussed above.

OBR evaluation process 245 and lodging rules database 244 contain the ability to convert the OBR to a GRR for specified day(s). Thus, when individual 120 desires, such as if an emergency occurs, individual 120 again contacts system 100, and provides his/her III, such as a code, and converts his/her OBR to GRR for specified day(s).

Preferably, also listed in lodging database 241 is such information as each respective lodging's star rating (5 star, 4 star, 3 star, 2 star, and 1 star), namely the classification indicating quality of service associated with each respective lodging 140, 150, 160, 170, and/or such information as each respective lodging's customer loyalty program. Then, individual 120 may choose a desired star rating when purchasing an OBR, and lodging 140, 150, 160, 170 may charge extra for a chosen star rating that is higher, such as a 5 star rating. Also, for individual 120 who indeed converts his/her OBR to a GRR, lodging 140, 150, 160, 170 may reward individual 120 with customer loyalty points with which individual 120 would have the ability to obtain in the future a reduced room rate, a free room for one or more nights, et cetera.

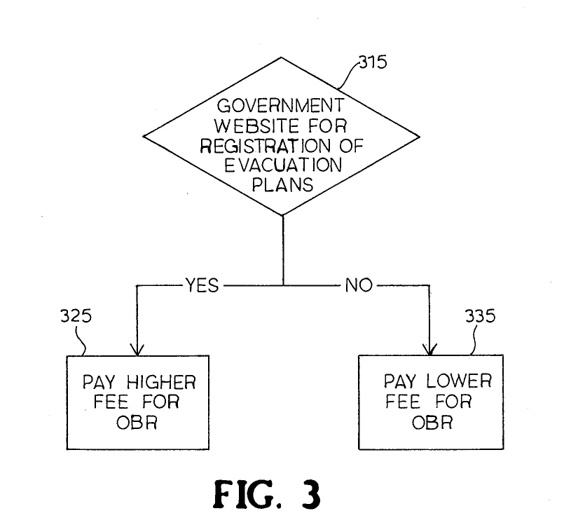

Optionally, in one embodiment, as depicted in FIG. 3, communication port 250 also communicates with government website 315, which provides a web page that is accessible on the world wide web, for both receiving and transmitting information in connection with OBRs. Suitably registration by individual 120 of his/her III and OBR on government website 315 may be a requirement by the United States government.

More particularly, government website 315 is for individuals 120 who reside in areas that are designated by the United States federal government as being areas prone to disasters/emergencies (i.e., coastal residents in hurricane areas, residents in earthquake areas, etc.) to register their evacuation plans, including destination, on government website 315. Website 315 may be a state website or country website, but preferably, is one United States government website 315 so that there is coordination throughout all of the United States for all of the evacuation plans for each individual 120 who registers. The registration will facilitate government officials planning how many spaces are needed in shelters versus how many individuals 120 have paid for and thus are registered with OBR system 100.

Government website 315 also will have a listing of United States government specified safe areas. In connection therewith, if the answer is YES for individual 120 to have purchased an OBR for a lodging room which is within government specified safe areas that are closer to the designated areas prone to disasters/emergencies, then individual 120 pays higher subscribing fee 325. If the answer is NO for individual 120 to have purchased an OBR for a lodging room which is within government specified safe areas that are closer to the designated areas prone to disasters/emergencies, so that individual 120 purchased an OBR for a lodging room which is farther away, outside the government specified safe areas, then individual 120 pays lower subscribing fee 335, which lower fee decreases the farther away from the government specified safe areas that the lodging room is.

Also, it is contemplated that other countries, besides the United States, may set up and operate such a government website 315 for individuals 120 respectively of those other countries to register their individual information and their evacuation plans, including destination, on the respective government websites 315 of the other countries.

This registration of evacuation plans on government website 315 optionally would include the government issuing registration for vehicles with RFID technology, so that the addresses of the vehicle owners would be recorded so that people within a certain area could be assigned a certain window of time and a certain route for evacuation, with RFID readers set up on access points to the evacuation routes.

### EXAMPLE

By means of, for instance, online access (i.e., the Internet), electronic mail, telephone, facsimile, in-person contact, or an agent 130, an individual 120 provides the OBR system 100 with the individual's offer for an OBR, including his/her III. The individual 120 and the lodgings 140, 150, 160, 170 employ a general purpose computer in order to communicate with the system 100, whereby the system 100 receives and processes the OBR.

Prior to the central controller 200 processing the OBR, the III data associated with the OBR is normalized with an offer table stored in the offer database 243. Also, the central controller 200 confirms that the individual 120 provided the appropriate III, for instance, including the individual's credit card number or other secured payment method, the individual's name, the individual's street address, the individual's email address, the individual's telephone number, et cetera. The data storage device 240 then stores the III in the III database 242.

The central controller 200 searches a table of lodgings maintained in the lodging database 241 and listing participating lodgings 140, 150, 160, 170 and listing the respective locations, brands and owners of the lodgings 140, 150, 160, 170. Also preferably listed in the lodging database 241 is such information as each respective lodging's star rating (5 star, 4 star, 3 star, 2 star, and 1 star), namely the classification indicating quality of service associated with each respective lodging 140, 150, 160, 170, so that an individual 120 can choose his/her desired star rating when purchasing an OBR, and/or such information as each respective lodging's customer loyalty program so that in individual 120 who indeed converts his/her OBR to a GRR is rewarded with the ability to obtain in the future a reduced room rate, a free room for one or more nights, et cetera. The search is effected in order to identify all participating lodgings 140, 150, 160, 170 that can fulfill the OBR (preferably, including the star rating if requested by the individual 120) and that are located in the geographic area designated in the OBR by the individual 120.

As long as one or more of the lodgings 140, 150, 160, 170 match the OBR requested by the individual 120, then the system 100 notifies the individual 120, and the individual 120 completes the request for an OBR, and is provided a code or selects a code, which is linked to the III and also stored along with the III in database 242.

However, if none of the lodgings 140, 150, 160, 170 matches the OBR requested by the individual 120, then the system 100 notifies the individual 120, and the individual 120 can terminate. Alternatively, the individual 120 can submit another, different request for an OBR, such as a request with a larger geographic area (with more lodgings), which request is then completed and the individual 120 is provided or selects a code.

A disaster/emergency arises, such as an approaching hurricane, and the individual 120 again contacts the system 100, for example, by means of online access (e.g., the Internet), electronic mail (email), telephone, facsimile, or in-person contact, or optionally through an agent 130, and again provides the system 100 with his/her III. Optionally, the individual 120 may contact the system 100 and convert the OBR to a GRR, even in the absence of a disaster/emergency.

More specifically, upon the central controller 200 of the system 100 subsequently obtaining the III that is subsequently provided by the individual 120, for instance, the individual 120 provides the code that the individual 120 was given or that the individual 120 designated when he/she first subscribed and paid the fee, then the central controller 200 transmits the III and converts the OBR to a GRR at a particular lodging belonging to the group of pre-selected lodgings 140, 150, 160, 170, whereby access to the room can be effected by the individual 120 for specified day(s).

Although the present invention has been shown and described in detail with regard to only a few exemplary embodiments of the invention, it should be understood by those skilled in the art that it is not intended to limit the invention to specific embodiments disclosed. Various modifications, omissions, and additions may be made to the disclosed embodiments without materially departing from the novel teachings and advantages of the invention, particularly in light of the foregoing teachings. Accordingly, it is intended to cover all such modifications, omissions, additions, and equivalents as may be included within the spirit and scope of the invention as defined by the following claims.

What is claimed is:

1. A method for validating an open basis reservation for a room at a particular lodging, where the particular lodging belongs to a group of pre-selected lodgings in a designated geographic area, said method comprising the steps of:
(a) making a reservation, on an open basis for an individual for a room in the group of pre-selected lodgings on a future unspecified day or days, by providing identification information on the individual and paying a fee for a term,
(b) storing reservation data in a reservation data storage area of a central controller, where the data includes the identification information on the individual and includes the group of pre-selected lodgings for which the open basis reservation has been made by the individual, and
(c) including ability to convert the open basis reservation to a guaranteed reservation for a room at the particular lodging belonging to the group of pre-selected lodgings for one or more specified days within the term, whereby access to the room can be effected by the individual for the one or more specified days, upon the central controller again obtaining the identification information on the individual when subsequently provided by the individual transmitting the identification information on the individual.

2. The method of claim 1, wherein the reservation data storage area includes a database for the identification information on the individual.

3. The method of claim 2, wherein database for the identification information on the individual generates one or both of (i) a reminder, on a periodic basis, to the individual, when the term of the paid subscribing fee is approaching expiration, so that the individual can periodically pay the fee and thereby periodically renew the term, or (ii) automatic periodic renewal payments of the term, until the individual gives notice to stop the automatic periodic renewal payments.

4. The method of claim 3, wherein the reminder comprises one or both of an email notice or a regular mail notice.

5. The method of claim 1, wherein making the open basis reservation is accomplished by means of one or more of online access, electronic mail, telephone, facsimile, in-person contact, or an agent.

6. The method of claim 1, wherein the identification information comprises a code that is given to the individual or that the individual designates when the individual first pays the periodic fee, and wherein the code links to the individual's identification information.

7. The method of claim 1, wherein the central controller includes a data storage device.

8. The method of claim 7, wherein the data storage device includes a lodging database, a database for identification information for the individual, an offer database, and a lodging rules database.

9. The method of claim 8, wherein the data storage device further includes an open basis reservation evaluation process and a rules evaluation subroutine.

10. The method of claim 9, wherein the open basis evaluation process receives each open basis reservation request from each individual, provides each open basis reservation to appropriate lodgings in the group of pre-selected lodgings, and evaluates each open basis reservation against rules in the lodging rules database, and determines acceptance of the open basis reservation by the lodgings.

11. The method of claim 10, wherein determination of acceptance of the open basis reservation is executed by the open evaluation process by the rules evaluation subroutine comparing the received open basis reservation against the rules in the lodging rules database.

12. The method of claim 1, further including registering the open basis reservation and the identification information on the individual, on a government website for registration of evacuation plans.

13. The method of claim 1, further including the central controller again obtaining the identification information on the individual when subsequently provided by the individual transmitting the identification information on the individual whereby the open basis reservation is converted to a guaranteed room reservation for one or more specified days and access to the room can be effected by the individual for the one or more specified days.

14. The method of claim 1, wherein the specified days are from 2 days to 6 days.

15. The method of claim 1, wherein the central controller has the ability to convert in a disaster/emergency, in absence of a disaster/emergency, or in a combination thereof.

16. The method of claim 15, wherein, when a disaster/emergency has occurred and a government evacuation order has been issued, and the individual, within a specified time after issuance of the evacuation order, fails to provide the identification information on the individual and to convert the open basis reservation to a guaranteed room reservation, the central controller has the ability to make the lodging room available to the general public during the instant disaster/emergency for which the government issued the evacuation order, and to make the individual forfeit his/her right to convert his/her open basis reservation to a guaranteed room at lodging in the pre-selected group for specified day(s) during the instant disaster/emergency for which the government issued the evacuation order.

17. The method of claim 15, wherein the central controller has the ability to charge an extra fee to include when one or more of the specified days is a blackout day.

18. A system for validating an open basis reservation for a room at a particular lodging, where the particular lodging belongs to a group of pre-selected lodgings in a designated geographic area, said system comprising:
(i) an electronic reservation data storage device of a central controller, said reservation data storage device (a) being for storing open basis reservation data received from an individual making a reservation, on an open basis, for a room in the group of pre-selected lodgings on a future unspecified day or days by providing identification information on the individual and paying a fee for a term, and (b) being capable of fulfilling the open basis reservation, where the reservation data includes identification information on the individual and includes the group of pre-selected lodgings for which the open basis reservation has been made by the individual,
and
(ii) a central processing unit of a central controller, said central processing unit (a) being for processing the open basis reservation for a room in the group of pre-selected lodgings on a future unspecified day or days, and (b) being in communication with the reservation data storage device in order to identify appropriate lodgings in the group of pre-selected lodgings capable of fulfilling the open basis reservation,
and
(iii) wherein the central controller has the ability (a) to search a database stored in the electronic storage device and accept the open basis reservation, and (b) to convert the open basis reservation to a guaranteed reservation for a room at the particular lodging belonging to the group of pre-selected lodgings for one or more specified days within the term, whereby access to the room can be effected by the individual for the one or more specified days, upon the central controller again obtaining the identification information on the individual when subsequently provided by the individual transmitting the identification information on the individual.

19. The system of claim 18, wherein the reservation data storage device includes a database for the identification information on the individual.

20. The system of claim 19, wherein the database for the identification information on the individual has the ability to generate one or both of (i) a reminder, on a periodic basis, to the individual, when the term or period of the paid subscribing fee is approaching expiration, so that the individual can periodically pay the fee and thereby periodically renew the term, or (ii) automatic periodic renewal payments of the term, until the individual gives notice to stop the automatic periodic renewal payments.

21. The system of claim 20, wherein the reminder comprises one or both of an email notice or a regular mail notice.

22. The system of claim 18, wherein the central controller has the ability to receive and to accept the open basis reservation by means of one or more of online access, electronic mail, telephone, facsimile, in-person contact, or an agent.

23. The system of claim 18, wherein the identification information comprises a code that is given to the individual or that the individual designates when the individual first pays the periodic fee, and wherein the code links to the individual's identification information.

24. The system of claim 18, wherein the data storage device includes a lodging database, a database for identification information for the individual, an offer database, and a lodging rules database.

25. The system of claim 24, wherein the data storage device further includes an open basis reservation evaluation process and a rules evaluation subroutine.

26. The system of claim 25, wherein the central controller has the ability to receive each open basis reservation request from each individual, to provide each open basis reservation to appropriate lodgings in the group of pre-selected lodgings, and to evaluate each open basis reservation against rules in the lodging rules database, and to determine acceptance of the open basis reservation by the lodgings.

27. The system of claim 26, wherein the central controller has the ability to determine acceptance of the open basis reservation by executing by the open basis reservation evaluation process by the rules evaluation subroutine and comparing the received open basis reservation against the rules in the lodging rules database.

28. The system of claim 18, further including an evacuation-plan government website for registering the open basis reservation and registering the identification information on the individual.

29. The system of claim 18, wherein the specified days are from 2 days to 6 days.

30. The system of claim 18, wherein the central controller has the ability to convert in a disaster/emergency, in absence of a disaster/emergency, or in a combination thereof.

31. The system of claim 30, wherein, the when a disaster/emergency has occurred and a government evacuation order has been issued, and the individual, within a specified time after issuance of the evacuation order, fails to provide the identification information on the individual and to convert the open basis reservation to a guaranteed room reservation, the central controller has the ability to make the lodging room available to the general public during the instant disaster/emergency for which the government issued the evacuation order, and to make the individual forfeit his/her right to convert his/her open basis reservation to a guaranteed room at lodging in the pre-selected group for specified day(s) during the instant disaster/emergency for which the government issued the evacuation order.

32. The system of claim 30, wherein the central controller has the ability to charge an extra fee to include when one or more of the specified days is a blackout day.
